(19) United States
(12) Patent Application Publication
(10) Pub. No.: US 2025/0028055 A1
(43) Pub. Date: Jan. 23, 2025

(54) METHOD FOR SATELLITE-SUPPORTED POSITION DETERMINING OF A LOCATOR DEVICE

(71) Applicant: IGASPIN GmbH, Graz (AT)

(72) Inventor: Amir Tabatabaei, Graz (AT)

(21) Appl. No.: 18/845,429

(22) PCT Filed: Mar. 8, 2023
(86) PCT No.: PCT/AT2023/060065

§ 371 Date: Sep. 9, 2024

(30) Foreign Application Priority Data
Mar. 10, 2022 (AT) A 50153/2022

(51) Int. Cl. G01S 19/11

(52) U.S. Cl. CPC G01S 19/11

(57) ABSTRACT

In a method for the satellite-supported position determining of a locator device (1) in a coverage area (2) with an insufficient-quality satellite signal (5a, 5b, 5c, 5d) of a satellite (6a, 6b, 6c, 6d), the satellite signal (5a, 5b, 5c, 5d) is received outside the coverage area (2) by an omnidirectional reference antenna (3), and a repeating signal pattern and the satellite position data are extracted from the satellite signal (5a, 5b, 5c, 5d). Replica signals (10a, 10b, 10c, 10d) are generated for multiple transmitter antennas (7a, 7b, 7c, 7d) in the coverage area (2). The difference between the delay time between a predefined target position in the transmission region (8a, 8b, 8c, 8d) of the respective transmitter antenna (7a, 7b, 7c, 7d) and the satellite (6a, 6b, 6c, 6d) and the delay time between the reference antenna (3) and the satellite (6a, 6b, 6c, 6d) is determined as a shift parameter Δt, and the replica signal (10a, 10b, 10c, 10d) is generated from the satellite position data and the signal pattern that has been temporally shifted by the shift parameter Δt. The satellite signal (5a, 5b, 5c, 5d) and the replica signal (10a, 10b, 10c, 10d) correspond in the periphery of the coverage area (2) to the extent that they are not distinguished by the locator device (1), and the difference of the shift parameters Δt for replica signals (10a, 10b, 10c, 10d) of adjacent transmission regions (8a, 8b, 8c, 8d) is smaller than half the duration of the signal pattern.

### FIELD OF THE INVENTION

The invention relates to a method for satellite-supported position determining of a locator device in a coverage area with insufficient quality of a satellite signal from a satellite.

### DESCRIPTION OF THE PRIOR ART

To determine the position of a locator device, it is known from the prior art that the locator device receives satellite signals (GNSS signals) with repeating signal patterns and satellite position data and determines the distance from the locator device to the respective satellite via the delay time of the satellite signals. In principle, the position of the locator device can be determined in this way using three different satellite signals from different satellites. However, since the locator device usually does not have a sufficiently accurate clock to correctly determine the transit time of the satellite signals, the satellite signal of a fourth satellite is used to enable sufficiently accurate position determining. This position determining method, which is known from the prior art, is also known as the pseudorange method and has the disadvantage that the locator device must receive the satellite signal from at least 4 satellites in order to determine the position with sufficient accuracy.

In order to also supply low-reception coverage areas such as tunnels with a satellite signal, it is therefore known from CN207301335U to arrange transmitting antennas in the tunnel, which transmitting antennas transmit coverage signals generated by a generator, which coverage signals can be received by a locator device of a train. However, a disadvantage of the method known from CN207301335U is that the coverage signals generated by the generator deviate from the actual satellite signals of the satellites outside the coverage area with weak reception, so that the coverage signals generated by the generator are perceived by the locator device as interference and are only used for position determining if their signal is many times (40-50 dB) stronger than the satellite signals, which means relatively resource-intensive signal generation for the transmitting antennas. In addition, various locator devices known from the prior art have algorithms to recognize such artificially amplified signals and not use them for position determining. Even if these generated coverage signals are used for position determining, imprecise position determining results at the transition from the high coverage area to the low coverage area due to the abrupt changeover of the locator device from the actual satellite signals of the satellites to the generated coverage signal of the generator.

U.S. Pat. No. 10,620,319B2 discloses a method for satellite-supported position determining of a locator device in a coverage area with insufficient quality of a satellite signal from a satellite. For this purpose, the satellite signals are received, then processed and transmitted to transmitting antennas arranged in a coverage area, with each transmitting antenna specifying a target position specific to it. At least four directional antennas are used for receiving, whereby each directional antenna is constantly aligned to a respective satellite by a control unit using beamforming. This alignment and tracking of the individual directional antennas requires a cost-intensive and complex control system. In addition, interference-free reception of the satellite signal of only the satellite to which the directional antenna is aligned is hardly possible by the directional antennas, as surrounding satellite signals or electromagnetic transmitters inevitably interfere with the satellite signal of the controlled satellite, for example through multipath propagation, so that the directional antennas tuned to a single satellite signal receive low-quality signals that are subject to interference. Due to these interference-prone, low-quality output signals, which are subsequently processed and transmitted to the transmitting antennas, the replica signals output by the transmitting antennas also have a low quality that deviates from the original satellite signals, which regularly leads to problems with the synchronization of the locator device. For this reason, the method is primarily suitable for use in closed rooms, so that the already disturbed replica signals emitted by the transmitting antennas are not additionally overlaid by other satellite signals. However, the distribution of the transmitting antennas in the closed rooms has the disadvantage that the tracking of the locator device is interrupted when moving from one room to another, which not only leads to an abrupt change in the target position, but also to a delay in position determining, as the locator device has to detect and track the new replica signal again.

DE102012007205 also discloses a method for satellite-supported position determining of a locator device in a coverage area with insufficient quality of a satellite signal from a satellite. The method uses a pseudolite which provides a target position to a locator device located in the coverage area, for example in a tunnel. The target position can be the center of the tunnel, for example. Accordingly, the method known from DE102012007205 only allows an imprecise position determining of the locator device.

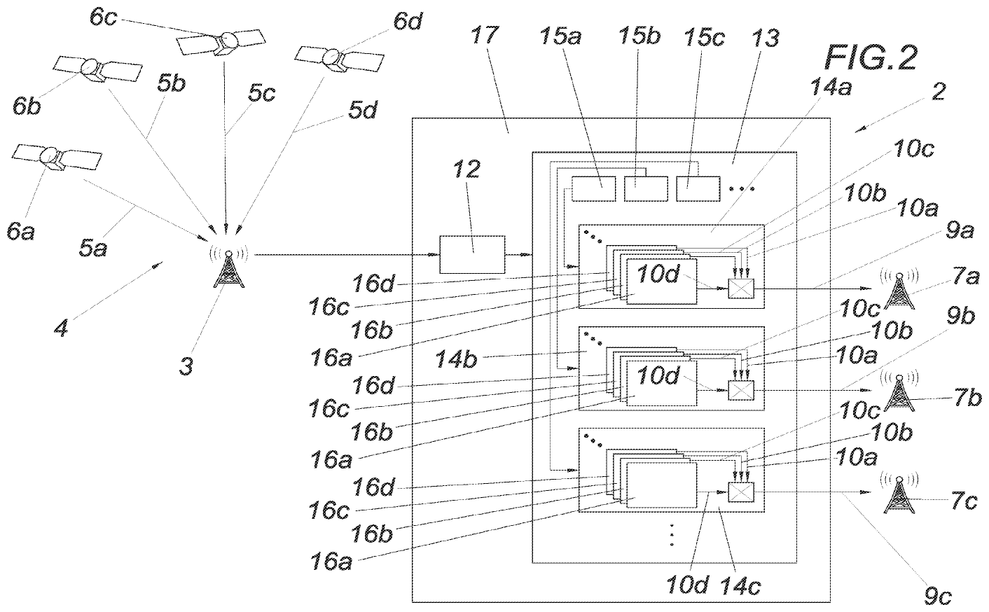

In WO2007/030384A2, a further method for satellite-supported position determining of a locator device in a coverage area with insufficient quality of a satellite signal from a satellite is disclosed. An embodiment example discloses a synchronization mode, for example shown in FIG. 2A, and discloses that satellite signals are received via a reference antenna and replica signals derived from the satellite signals are transmitted to a transmitting antenna, via which replica signals the position of the transmitting antenna is specified to a locator device as a target position. If the locator device is located in a coverage area with weak reception, the replica signals transmitted by the transmitting antenna are used for position determining. If the locator device is located in an area with strong reception, the satellite signals are used. In synchronization mode, the replica signals emitted by the transmitting antenna are synchronized with the satellite signals that would prevail at the exact location of the transmitting antenna. The disadvantage of this, however, is that the locator device always outputs the same target position transmitted by the transmitting antenna, regardless of the exact position in the coverage area with weak reception, which leads to a large error for locator devices that are far away from this target position. In addition, especially in the case of wide coverage areas, where the transmitting antenna is far away from the transition area between the coverage area and the area with strong reception, errors occur during synchronization due to the different signal characteristics of the replica signal output by the transmitting antenna and the satellite signals, since the locator device has to make a sudden change during tracking, which in turn leads to a delay in position determining. Another embodiment example discloses, for example shown in FIG. 6, that a plurality of transmitting antennas are provided, wherein the transmitting antennas generate the replica signal according to a computer network mode, whereby the replica signals are synchronized with the original satellite signals only at the beginning and then the replica signals are generated autonomously. Especially when the locator device remains in the coverage area for a long time, this results in synchronization-related errors in position determining in the transition area between the coverage area and the area with strong reception, as the accessibility to satellite signals is constantly changing and thus differs more and more from the replica signals as time passes. There are also sudden changes in position determining in the transition area between two different transmission regions of different transmitting antennas. Another disadvantage is that a separate GNSS emitter must be provided for each transmitting antenna, which means high costs and computational effort.

### SUMMARY OF THE INVENTION

The invention is thus based on the task of proposing a method for supplying a coverage area with a satellite signal, which allows resource-saving operation of several transmitting antennas and enables sufficiently accurate position determining in the coverage area, as well as at the transition area between the coverage area and the area with strong reception, regardless of the type of coverage area with weak reception, without having to adapt locator devices known from the prior art for this purpose.

The invention solves the task set by receiving the satellite signal outside the coverage area by an omnidirectional reference antenna and extracting a repeating signal pattern and the satellite position data from the satellite signal, after which a respective replica signal is generated for each of a plurality of transmitting antennas in the coverage area, wherein the difference between the delay time between a predetermined target position in the transmission region of the respective transmitting antenna and the satellite and the delay time between the reference antenna and the satellite is determined as a shift parameter and the replica signal is generated from the satellite position data and the signal pattern that has been temporally shifted by the shift parameter, wherein the satellite signal and the replica signal in the peripheral area of the coverage area correspond to such an extent that they are not distinguished by the locator device and wherein the difference of the shift parameters At for replica signals of adjacent transmission regions is less than half the duration of the signal pattern. As a result of the measures according to the invention, a seamless transition of the locating of the locator device at the transition area between an area in which the locator device can receive the satellite signal and therefore uses this satellite signal for position determining and the transmission region in the coverage area can be achieved. So that the locator device does not or cannot distinguish between the satellite signal and the replica signal in the peripheral area of the coverage area, the replica signal emitted in the peripheral area of the coverage area via the respective transmitting antenna is basically synchronized with the satellite signal or coherent with the satellite signal and only slightly shifted by the shift parameter. This enables interference-free synchronization by the locator device, regardless of the type of coverage area, so that undisturbed position detection of the locator device is also possible at the transition area between the coverage area and the strong reception area, where a weak satellite signal can still be received, for example. Isolation of the original satellite signal is therefore not necessary. The locator device therefore does not detect any difference between the actual satellite signal and the generated replica signal at the transition area between the transmission region in the coverage area and the strong reception area. This avoids synchronization-related errors in position determining in the coverage area with weak reception, without impairing the functionality of the locator device in areas with strong reception, as is known from the prior art. All that is required for the invention is that the satellite signals are processed in real time and the replica signals generated from them are transmitted to the transmitting antennas in real time. Since the difference between the shift parameters Δt for replica signals of adjacent transmission regions is less than half the duration of the signal pattern, a seamless transition of the locating method of the locator device between transmission regions of different transmitting antennas can be achieved. By maintaining the shift parameter Δt according to the invention, the tracking loop of the locator device can be shifted gradually in the desired direction, whereby the position that is output by the locator device also moves smoothly without abrupt changes. When moving the locator device from one transmission region to another transmission region, intermediate positions located on a trajectory can therefore be predefined, with the trajectory running between the predefined target positions of the respective transmitting antennas of the adjacent transmission regions. The locator device can therefore also perform uninterrupted tracking in the transition region between two transmission regions. Accordingly, the locator device can also determine its position step by step using the replica signals received in each transmission region. To generate the replica signals, a generator can be provided which has a processing unit for each transmitting antenna to which processing unit a target position presetting unit is assigned. In this way, the replica signals for each transmitting antenna can be generated centrally by the generator and then transferred independently of each other to the respective transmitting antennas. This results in particularly resource-efficient signal generation.

In the method according to the invention, a satellite signal is first received outside the coverage area by a reference antenna. For this purpose, the reference antenna is arranged in an area with strong reception, i.e. in an area in which satellite signals from satellites can be received. To determine the position of the locator device, the reference antenna can receive satellite signals of at least four different satellites. For this purpose, the reference antenna is designed as an omnidirectional reference antenna.

In a manner known from the prior art, the satellite signal has a carrier phase, a repeating, pseudo-random signal pattern and a navigation message with satellite position data. The repeating signal pattern and the satellite position data are extracted from the received satellite signal and used to generate the replica signal.

For this purpose, the satellite signal is acquired, demodulated by a carrier wave if necessary and tracked. Tracking can be carried out using the DLL (Delay Lock Loop) and/or PLL (Phase Lock Loop) and/or FLL (Frequency Lock Loop) methods known from the prior art. The tracking provides information about the delay time of the satellite signal from the satellite to the reference antenna in a manner known from the prior art, so that with the known formula

$$ρ = t * c ( t = delay time [ s ] , c = speed of light [ m / s ] , ρ = pseudorange [ m ] )$$

the pseudorange between the satellite and the reference antenna and subsequently the position of the reference antenna can be determined. For unambiguous position determining according to the pseudorange method known from the prior art, four pseudoranges between the reference antenna and four different satellites must be known.

However, as the positions of the transmission regions of the transmitting antennas located in the coverage area differ from the position of the reference antenna, a separate replica signal is generated for each transmitting antenna, in which the tracked satellite signal for each transmitting antenna is modified individually by a shift parameter Δtⁱ. This shift parameter Δtⁱ corresponds to the difference between the delay time between a specified target position in the transmission region of the respective transmitting antenna and the satellite t_{ZS}ⁱ and the delay time between the reference antenna and this satellite t_{RS}ⁱ. The shift parameter according to the invention Δtⁱ is calculated by:

$$\begin{matrix}Δ {t}^{i} = {t}_{R S}^{i} - {t}_{Z S}^{i} \\ t = \frac{ρ}{c} \\ Δ {t}^{i} = \frac{{\hat{ρ}}_{i n t}^{i} - {\hat{ρ}}_{ref}^{i}}{c}\end{matrix}$$

With

it results in
\hat{ρ}ᵢₙₜⁱ is the pseudorange between target position and satellite i
\hat{p}_{ref}ⁱ is the pseudorange between the reference antenna and satellite i

According to the invention, the coverage area is divided into transmission regions of several transmitting antennas, with a target position being specified in each transmission region Xᵢₙₜ which target position the locator device is to adopt as its own position when it is located in the respective transmission region.

With

$${\hat{ρ}}_{int}^{i} = ‖ {X}_{int} - {X}^{i} ‖ + {b}^{i}$$

Xᵢₙₜ is the given target position (known)
Xⁱ is the satellite position (known)
bⁱ various pseudorange errors (satellite clock error, ionospheric delay, tropospheric delay, receiver clock deviation etc.) with regard to the satellite signal i

And with

$${\hat{ρ}}_{r e f}^{i} = ‖ {X}_{r e f} - {X}^{i} ‖ + {b}^{i}$$

X_{ref} is the reference position of the reference antenna (determined)

Results in

$$Δ {t}^{i} = \frac{{\hat{ρ}}_{i n t}^{i} - {\hat{ρ}}_{r e f}^{i}}{c} = \frac{‖ {X}_{i n t} - {X}^{i} ‖}{c} - \frac{‖ {X}_{r e f} - {X}^{i} ‖}{c} + Δ {B}_{MK - ctrl}^{i}$$

ΔB_{MK_ctri} are errors with regard to the processing and control time of the method according to the invention

If this shift parameter Δtⁱ is known, the replica signal for a transmitting antenna can be derived from the satellite signal by shifting the repeating signal pattern of the satellite signal by the shift parameter Δtⁱ and the shifted signal pattern is recombined with the satellite position data or with the navigation message to form the replica signal, which is then subsequently modulated back onto a carrier wave before being transmitted in this form to the respective transmitting antenna. Since both the reference antenna and the target position are constant in the transmission region of the transmitting antenna, any Doppler shift essentially depends on the movement of the respective satellite, whereby this Doppler shift between the satellite signal and the replica signal can remain the same due to the comparatively small distance between the reference antenna and the target position.

To ensure that the satellite signal and the replica signal in the peripheral area of the coverage area correspond to such an extent that they are not distinguished by the locator device, it is proposed that for the transmission region of a transmitting antenna in the peripheral area of the coverage area, the difference between the delay time between the satellite and the locator device in the transmission region and the delay time between the satellite and the predetermined target position in the transmission region is less than half the duration of the signal pattern. In commercially available satellite navigation systems, for example, the signal pattern is repeated every millisecond (GPS L1), so that the required half duration of the signal pattern corresponds to 0.5 milliseconds. This means that the target position in a peripheral area of the coverage area in this example cannot be further than 150 m from the edge of the coverage area.

In order to enable not only a seamless transition of the locator device's position determining method in the peripheral area of the coverage area, but also a seamless transition between transmission regions of different transmitting antennas, it is proposed that the difference in the shift parameters for replica signals of adjacent transmission regions is less than half the duration of the signal pattern.

Although the method according to the invention can be used to generate replica signals for only individual satellites, while other satellites in the coverage area are received without interference, usually only a few or no satellite signals can be received in a coverage area, so that position determining can only be made possible with the aid of replica signals. For this purpose, it is proposed that the satellite signals of a plurality of satellites are received by the reference antenna, the repeating signal pattern and the satellite position data being extracted from the satellite signal for each satellite, the difference between the delay time between a predetermined target position in the transmission region of the respective transmitting antenna and the satellite and the delay time between the reference antenna and the satellite is determined as a shift parameter and the replica signal is generated from the satellite position data and the signal pattern that has been temporally shifted by the shift parameter, wherein a coverage signal for the transmission region of a transmitting antenna is generated from the replica signals transmitting antenna and is transmitted to the transmitting antenna. A coverage signal therefore comprises at least four replica signals, each of which is shifted by a specific shift parameter so that, apart from minor deviations resulting from processing, these correspond to the satellite signals theoretically received at the target location of the transmission region, provided that undisturbed reception would be possible at the target location. To generate the coverage signals, a generator can be provided which has a processing unit for each transmitting antenna, to which processing unit a target position presetting unit is assigned. In this way, the coverage signals for each transmitting antenna can be generated centrally by the generator and then transferred to the respective transmitting antennas independently of each other. This results in particularly resource-efficient signal generation.

If a locator device is located in an area with strong reception, it is located using the actual satellite signals. If the locator device enters a reception range of a transmitting antenna in the coverage area, the locator device receives the coverage signal comprising at least four replica signals via the transmitting antenna. As a result of the method according to the invention, the replica signals match the satellite signals apart from minor deviations, so that the locator device does not perceive the replica signals as interference signals and therefore a seamless transition of the tracking process of the locator device takes place, in particular in the transition area between the area with strong reception and the coverage area. In the transmission region of the respective transmitting antenna, the locator device receives the replica signals processed with the shift parameter and uses these replica signals to calculate the respective pseudoranges \hat{ρ}ᵢₙₜⁱ and uses at least four pseudoranges \hat{ρ}ᵢₙₜⁱ to determine the predeterminable target position.

According to the invention, the replica signals or the coverage signals are generated comprising at least four replica signals for all transmission regions of the transmitting antennas.

In order to enable a higher resolution in position determining in the coverage area with only insufficient quality of one or more satellite signals, it is proposed that the coverage area is divided into at least two coverage area units, with at least two transmitting antennas being arranged in each coverage area unit. In the context of the invention, a coverage area unit is understood to be a contiguous space in which signal propagation can take place without interference to the extent that the locator device can receive the signals from the at least two transmitting antennas at at least one position and process them without errors. A coverage area unit can therefore be considered to be a closed room of a building to which another room adjoins as a further coverage area unit. The two rooms as separate coverage area units can be separated from each other by a wall as an interference object. In this way, several target positions can be specified in one coverage area unit, as each transmitting antenna can specify a specific target position for itself. The transmitting antennas are arranged in the coverage area units in such a way that they can receive the coverage signals. Preferably, directional antennas are used as transmitting antennas.

Preferably, the directional antennas have a beam width of less than or equal to 65°, in particular less than or equal to 60°. Preferably, the transmission region of a directional antenna has a radius of less than or equal to 4 m, more preferably less than or equal to 2 m, in particular less than or equal to 1.5 m. In this way, the error of the locator device in adjacent transmission regions can be limited to 3 m.

The invention also relates to a device for carrying out the method according to the invention, having a reference antenna for receiving a satellite signal, a receiving unit for extracting the repeating signal pattern and the satellite position data from the satellite signal, a generator for generating coverage signals and a plurality of transmitting antennas for transmitting these coverage signals in a respective transmission region of a coverage area, the generator having, for each transmitting antenna, a processing unit to which a target position presetting unit is assigned.

The reference antenna is located in a strong reception area outside the coverage area and receives a satellite signal, or satellite signals from four different satellites, in order to achieve position determining. In order to avoid interference between a commercially available locator device and the device, it is advantageous if the reference antenna has access to the same satellite signals, or at least a large proportion of the same satellite signals as the locator device when it is still in the peripheral area between the strong reception area and the coverage area. This means that the transit time deviations of the satellite signals between the reference antenna and the first transmitting antenna in the coverage area into whose reception range the locator device enters should be small.

The GNSS satellite signals received are forwarded by the reference antenna to a receiving unit. Preferably, the receiving unit comprises a pre-processing unit which converts the radio frequency signal transmitted by the reference antenna into an intermediate frequency signal and digitizes it.

The digitized satellite signals are acquired and tracked in the receiver unit. In addition, the position determining of the reference antenna can be carried out using the pseudorange method known from the prior art.

The generator according to the invention generates the replica signals by shifting the repeating signal pattern of the satellite signal i by the shift parameter Δtⁱ and recombining the shifted signal pattern together with the satellite position data or with the navigation message to form the replica signal. For this purpose, the generator has a separate processing unit for each transmitting antenna, whereby each processing unit is given the target position Xᵢₙₜ of the associated transmitting antenna. This has the advantage that the replica signals for each transmitting antenna are generated centrally by the generator and then transferred to the respective transmitting antennas independently of each other, which results in particularly resource-efficient signal generation. The target position is given to the processing unit by a target position presetting unit, which can comprise a memory in which the respective target position in the transmission region of the respective transmitting antenna can be stored, for example when the transmitting antenna is installed. In this way, a specific shift parameter Δtⁱ is calculated for each satellite signal i by which specific shift parameter Δtⁱ the signal pattern for generating the replica signal must be shifted so that a locator device can calculate the desired pseudorange. The specific shift parameters Δtⁱ of different processing units therefore result from the different target positions Xᵢₙₜ.

$$Δ {t}^{i} = \frac{{\hat{ρ}}_{i n t}^{i} - {\hat{ρ}}_{r e f}^{i}}{c} = \frac{‖ {X}_{i n t} - {X}^{i} ‖}{c} - \frac{‖ {X}_{r e f} - {X}^{i} ‖}{c} + Δ {B}_{MK - ctrl}^{i}$$

At least four satellite signals i are required for exact position determining. This means that each processing unit can have at least four channel units. In each channel unit, a specific shift parameter Δtⁱ can be calculated to generate the replica signal. The specific shift parameters Δtⁱ in the different channel units within a processing unit thus result from the different satellite positions Xⁱ with a constant position of the reference antenna X_{ref} and constant target position Xᵢₙₜ. The position of the reference antenna X_{ref} antenna is the same for all processing units of the generator, while the target position is Xᵢₙₜ is specified specifically for each processing unit.

According to the invention, the generator therefore calculates a specific shift parameter for all transmitting antennas and all satellite signals and, by shifting the signal patterns, generates those replica signals which are used by the locator device in the respective transmission region of a transmitting antenna to locate the desired target position. Due to the design of the generator according to the invention, the calculation of the required shift parameters for all transmitting antennas and all satellite signals can be carried out in parallel.

After the replica signals have been generated, this or a coverage signal comprising the replica signals is transmitted to the associated transmitting antenna for each processing unit. Transmission can take place via a transmission unit of the generator, which modulates the individual replica signals onto a carrier wave and combines them into a coverage signal. The coverage signal of the respective processing unit is transmitted to the transmitting antenna assigned to the processing unit, which transmitting antenna in turn transmits the coverage signal to the locator device as soon as it enters the transmission region of the transmitting antenna.

If a locator device is initially located in an area with strong reception, position determining can be carried out using the satellite signals. If the locator device enters a transmission region of a transmitting antenna, the coverage signal generated by the processing unit of the generator associated with this transmission region is imposed on the locator device. Since the replica signals of the coverage signal essentially match the satellite signals except for small deviations, the locator device does not recognize any difference between the signals, especially in the transition area between the reception area and the transmission region, and uses the coverage signal to determine the position without having to make a sudden change during acquisition and tracking.

In order to enable exact localization in a large coverage area equipped with many transmitting antennas without causing mutual interference signals, it is proposed that the transmitting antennas are directional antennas. In particular, the transmitting antennas are arranged in the coverage area in such a way that their transmission regions do not overlap. The directional antennas are characterized by a narrow beam width so that overlapping of the different transmission regions is prevented.

Preferably, the directional antennas have a beam width of less than or equal to 65°, in particular less than or equal to 60°. Preferably, the transmission region of a directional antenna has a radius of less than or equal to 4 m, more preferably less than or equal to 2 m, in particular less than or equal to 1.5 m. In this way, the error of the locator device in adjacent transmission regions can be limited to 3 m.

In order to also avoid undesirable interference between the transmitting antennas and the satellite signals from the satellites in the border area between the coverage area and the area with strong reception, the coverage signal transmitted by the transmitting antennas in the coverage area can have a higher signal strength than the satellite signals from the satellites.

In a particularly preferred embodiment, the device has a multi-channel transceiver which comprises a receiving unit and a generator and which is connected to the reference antenna on the input side and to transmitting antennas on the output side.

The receiving unit can comprise a pre-processing unit and a software-defined radio receiver (SDRR). The generator can comprise a software-defined radio transmitter (SDRT), which generates the replica signals and the resulting coverage signals based on previously determined shift parameters.

To cover a larger coverage area, a device according to the invention may have several multi-channel transceivers connected to a common time and frequency base.

### BRIEF DESCRIPTION OF THE INVENTION

The drawing shows an example of the object of the invention, wherein

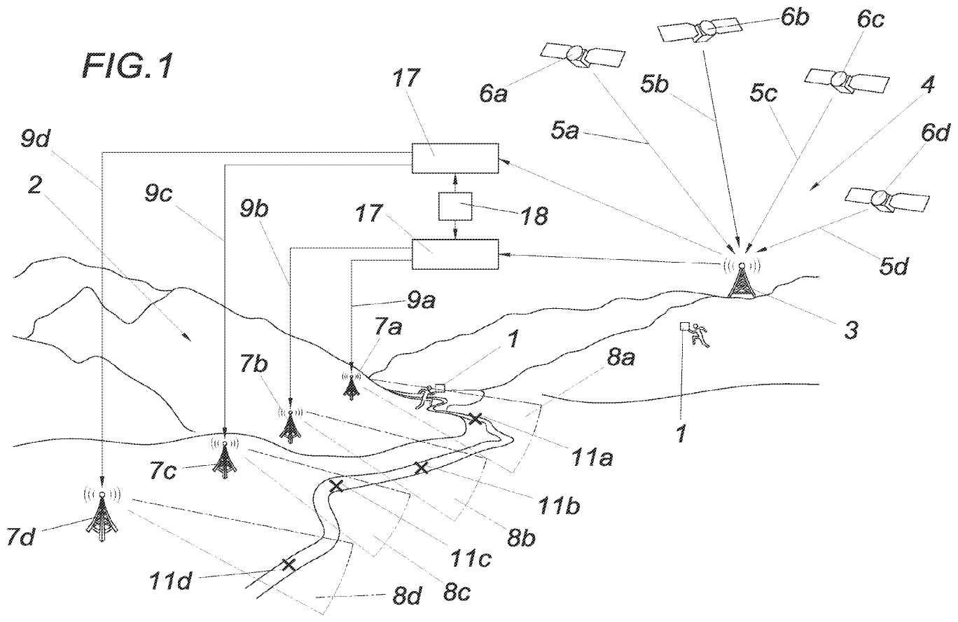

FIG. 1 shows a schematic representation of the deployment of a coverage area with a satellite signal according to the invention,

FIG. 2 shows a schematic representation of the method according to the invention and the device according to the invention, and

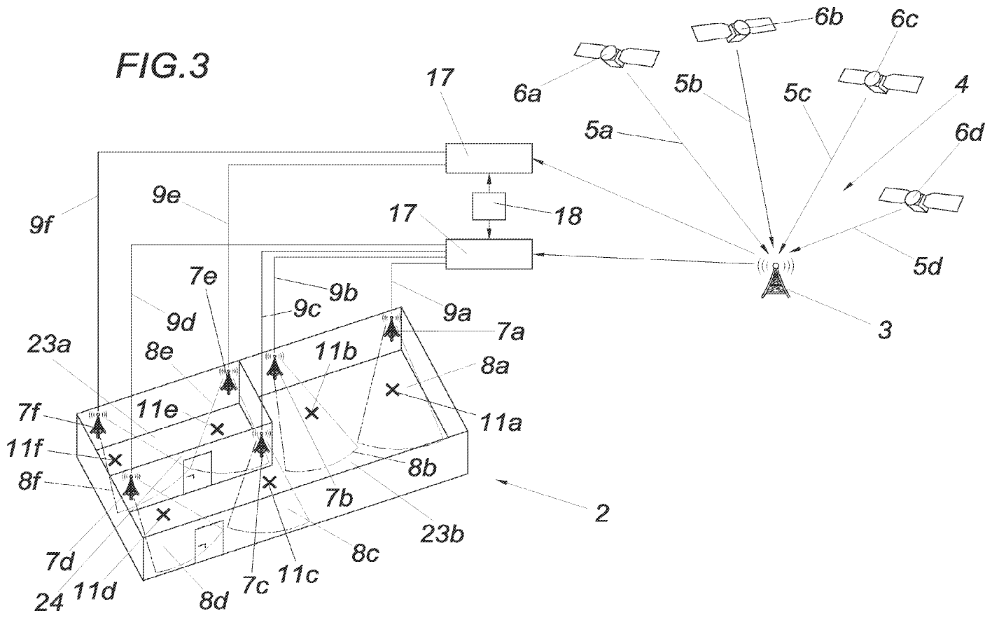

FIG. 3 shows a schematic representation of the deployment of another coverage area with a satellite signal according to the invention.

### DESCRIPTION OF THE PREFERRED EMBODIMENTS

As can be seen from FIG. 1, in a method according to the invention for satellite-supported position determining of a locator device 1 in a coverage area 2, a reference antenna 3 is used, which is arranged in a strong reception area 4 outside the coverage area 2. While satellite signals 5a, 5b, 5c, 5d from satellites 6a, 6b, 6c, 6d are accessible to the strong reception area, they are not accessible or only accessible to a limited extent to coverage area 2. Transmitting antennas 7a,7b,7c,7d are arranged in the coverage area 2, which transmit coverage signals 9a,9b,9c,9d, preferably comprising at least four replica signals 10a,10b,10c,10d (FIG. 2), in their respective transmission region 8a,8b,8c,8d. If a locator device 1 known from the prior art is located in an area 4 with strong reception, position determining can be carried out in a known manner using the satellite signals 5a,5b,5c,5d of the satellites 6a,6b,6c,6d. In coverage area 2, these satellite signals 5a,5b,5c,5d are no longer accessible to locator device 1, or only to a limited extent. Accordingly, when the locator device 1 enters a transmission region 8a, 8b, 8c, 8d, it receives the coverage signal 9a. Since the coverage signal 9a essentially matches the satellite signals 5a,5b,5c,5d except for small deviations, the locator device 1 does not recognize any difference between the signals, especially in the transition area between the reception area 4 and the transmission region 9a, and uses the coverage signal 9a for position determining without having to make a sudden change during acquisition and tracking. For representative position determining of the locator device 1, the coverage signals 9a,9b,9c,9d must have a different information content than the satellite signals 5a,5b,5c,5d at the position of the reference antenna 3, since otherwise the locator device 1 would determine the position of the reference antenna 3 as its own in the transmission regions 8a,8b,8c,8d if only the satellite signals 5a,5b,5c,5d are transmitted from the transmitting antennas 7a,7b,7c,7d to the locator device 1. The coverage signals 9a,9b,9c,9d are therefore processed according to the invention in such a way that the locator device 1 determines a predeterminable target position 11a,11b,11c,11d in the transmission regions 8a,8b,8c,8d from the respective coverage signals 9a,9b,9c,9d.

The processing according to the invention is explained in more detail with reference to FIG. 2, which shows a device according to the invention for satellite-supported position determining in a coverage area 2. A device according to the invention has a reference antenna 3 which is arranged in a strong reception area 4 and thereby receives satellite signals 5a, 5b, 5c, 5d from at least four satellites 6a, 6b, 6c, 6d. The reference antenna 3 is an omnidirectional reference antenna 3. The received satellite signals 5a,5b,5c,5d are transferred to a receiving unit 12. In the receiving unit 12, the satellite signals 5a, 5b, 5c, 5d are detected and tracked and the position determining of the reference antenna 3 is performed in a manner known from the prior art. Preferably, the receiving unit 12 comprises a preprocessing unit for converting and digitizing the satellite signals 5a,5b,5c,5d. In the receiving unit 12, for each satellite signal 5a,5b,5c,5d, its repeating signal pattern and satellite position data are extracted and the position of the reference antenna 3 is determined therefrom using the pseudorange method known from the prior art.

A generator 13 generates the replica signals 10a,10b,10c,10d from the extracted signal patterns and the satellite position data by shifting the repeating signal pattern of the satellite signal 5a,5b,5c,5d by a shift parameter Δt^{5a,5b,5c,5d} and by recombining the shifted signal pattern with the satellite position data or with the navigation message to form the replica signal 10a,10b,10c,10d. Using the shift parameter Δt^{5a,5b,5c,5d} the replica signal 10a,10b,10c,10d is therefore changed in such a way that a locator device 1 does not determine the position of the reference antenna 3, but a desired target position 11a,11b,11c,11d. The generator 13 therefore has a separate processing unit 14a,14b,14c,14d for each transmitting antenna 7a,7b,7c,7d. Each processing unit 14a,14b,14c,14d is assigned a target position presetting unit 15a,15b,15c, which provides the processing unit 14a,14b,14c,14d with the desired and known target position 11a,11b,11c,11d in the transmission region 8a,8b,8c,8d of the respective transmitting antenna 7a,7b,7c,7d. In this way, in each processing unit 14a,14b,14c,14d a specific shift parameter Δt^{5a,5b,5c,5d} is calculated for each satellite signal 5a,5b,5c,5dc, by which specific shift parameter Δt^{5a,5b,5c,5d} the signal pattern for generating the replica signal 10a,10b,10c,10d must be shifted so that a locator device 1 calculates the desired pseudorange.

Since at least four satellite signals 5a,5b,5c,5d must be provided for position determining using the pseudorange method, each processing unit 14a,14b,14c,14d can generate at least four replica signals 10a,10b,10c,10d, which can be combined to form a coverage signal 9a,9b,9c,9d. For this purpose, each processing unit 14a,14b,14c,14d can have a separate channel unit 16a,16b,16c,16d, i.e. at least four channel units 16a,16b,16c,16d, for each replica signal 10a,10b,10c,10d to be generated. In each channel unit 16a,16b,16c,16d, a specific shift parameter Δt^{5a,5b,5c,5d} for generating the replica signal 10a,10b,10c,10d can be calculated. While the specific shift parameters Δt^{5a,5b,5c,5d} of different processing units 14a,14b,14c,14d result from the different target positions 11a,11b,11c,11d (Xᵢₙₜ), the specific shift parameters Δt^{5a,5b,5c,5d} of different channel units 16a,16b,16c,16d within a processing unit 14a,14b,14c,14d result from the different satellite positions (Xⁱ) with a constant position of the reference antenna 3 (X_{ref}) and constant target position 11a,11b,11c,11d (Xᵢₙₜ).

$$Δ {t}^{i} = \frac{{\hat{ρ}}_{i n t}^{i} - {\hat{ρ}}_{r e f}^{i}}{c} = \frac{‖ {X}_{i n t} - {X}^{i} ‖}{c} - \frac{‖ {X}_{r e f} - {X}^{i} ‖}{c} + Δ {B}_{MK - ctrl}^{i}$$

The replica signals 10a,10b,10c,10d are combined in each processing unit 14a,14b,14c,14d to form coverage signals 9a,9b,9c,9d, each coverage signal 9a,9b,9c,9d being transmitted to the respective transmitting antenna 7a,7b,7c,7d, which, as indicated in FIG. 1, transmits the coverage signals 9a,9b,9c,9d in the transmission region 8a,8b,8c,8d. For reasons of clarity, only three transmitting antennas 7a, 7b, 7c are shown in FIG. 2 and four in FIG. 1. Naturally, more transmitting antennas 7a, 7b, 7c, 7d can also be provided.

The more transmitting antennas 7a,7b,7c,7d are set up in the coverage area 2, the more accurate the position determining can be. Directional antennas can be used so that many transmitting antennas 7a,7b,7c,7d can be arranged next to each other in a confined space without interference, as these have a narrow transmission region 8a,8b,8c,8d.

As can be seen from FIG. 1, the transmitting antennas 7a, 7b, 7c, 7d are arranged in the coverage area 2 in such a way that their transmission regions 8a, 8b, 8c, 8d do not overlap.

In order to enable an interference-free transition for the locator device 1 from the area with strong reception to the coverage area 2, the coverage signal 9a,9b,9c,9d transmitted by the transmitting antennas 7a,7b,7c,7d in coverage area 2 can have a higher signal strength than the satellite signals 5a,5b,5c,5d of the satellites 6a,6b,6c,6d.

For resource-saving processing of the satellite signals 5a,5b,5c,5d into several coverage signals 9a,9b,9c,9d, at least one multi-channel transceiver 17 can be provided which comprises a receiving unit 12 and a generator 13 and which is connected on the input side to the reference antenna 3 and on the output side to transmitting antennas 7a,7b,7c,7d. Since multi-channel transceivers 17 usually have only a limited number of processing units 14a,14b,14c and thus also inputs and outputs, several multi-channel transceivers 17 can be provided to cover a larger coverage area 2, which are connected to a common time and frequency base 18.

FIG. 3 illustrates that the coverage area can be divided into at least two coverage area units 23a, 23b. At least two transmitting antennas 7a, 7b, 7c, 7d, 7e, 7f can be arranged in each coverage area unit 23a, 23b. The coverage area units 23a, 23b can be understood as signal interference-free contiguous spaces. Accordingly, a room of a building can be regarded as a coverage area unit. A further room can be adjacent to the room as a further coverage area unit 23b. The two rooms can be separated from each other by a wall 24 as an interfering object, whereby the coverage area units 23a, 23b are separated from each other. As a result of the preferred measures according to the invention, a higher resolution can be achieved in position determining, since several target positions 11a,11b,11c,11d,11e,11f can be specified for each coverage area unit 23a,23b. The transmitting antennas 11a,11b,11c,11d,11e,11f are preferably arranged in the peripheral area of the coverage area units 23a,23b so that these can receive the coverage signals 9a,9b,9c,9d,9e,9f.

1. A method for determining a position of a locator device in a coverage area with insufficient quality of a satellite signal of a satellite, said method comprising:
receiving the satellite signal outside the coverage area with an omnidirectional reference antenna; and
extracting a repeating signal pattern and satellite position data from the satellite signal; and
generating a respective replica signal for each of a plurality of transmitting antennas in the coverage area;
determining a difference between a delay time between a predetermined target position in a transmission region of the respective transmitting antenna and the satellite and a delay time between the reference antenna and the satellite as a shift parameter Δt; and
wherein the generating of the replica signals signal is from the satellite position data and the signal pattern that has been temporally shifted by the shift parameter Δt;
wherein the satellite signal and the replica signal correspond in a peripheral area of the coverage area to such an extent that the satellite signal and the replica signal are not distinguished by the locator device; and
wherein the difference of the shift parameters Δt for the replica signals of adjacent transmission regions is less than half of a duration of the signal pattern.

2. The method according to claim 1, wherein, for the transmission region of one of the transmitting antennas in the peripheral area of the coverage area, a difference between a delay time between the satellite and the locator device in the transmission region and the delay time between the satellite and the predetermined target position in the transmission region is less than half the duration of the signal pattern.

3. The method according to claim 1, wherein a plurality of additional satellites each transmit a respective satellite signal, and the method further comprises
receiving the satellite signals of said plurality of additional satellites with the reference antenna;
extracting a respective repeating signal pattern and satellite position data from the satellite signal for each of the additional satellites;
determining a difference between the delay time between a predetermined target position in the transmission region of the respective transmitting antenna and the respective additional satellite and the delay time between the reference and the respective additional satellite as a respective shift parameter Δt; and
generating the replica signal from the satellite position data and the signal pattern that has been temporally shifted by the respective shift parameter Δt; and
generating a coverage signal for the transmission region of a respective transmitting from the replica signals transmitting antenna, and transmitting the coverage signal to the transmitting antenna.

4. The method according to claim 1, wherein the coverage area is subdivided into at least two coverage area units, at least two of said transmitting antennas being arranged in each coverage area unit.

5. A device for carrying out a method according to claim 1, comprising;
an omnidirectional reference antenna for receiving a satellite signal, a receiving unit extracting the repeating signal pattern and the satellite position data from the satellite signal,
a generator generating coverage signals, and
a plurality of transmitting antennas for each transmitting a respective one of said coverage signals in a respective transmission region of a coverage area,
wherein the generator has a processing unit for each transmitting, and each of said processing units unit has a target position presetting unit assigned thereto.

6. The device according to claim 5, wherein the coverage signals comprise replica signals, and wherein the processing units comprise a channel unit for each replica signal for generating the replica signals in parallel.

7. The device according to claim 5, wherein the transmitting antennas are directional antennas.

8. The device according to claim 5, wherein the transmitting antennas are arranged in the coverage area in such that the transmission regions thereof do not overlap.

9. The device according to claim 5, wherein the coverage signals transmitted by the transmitting antennas have a higher signal strength than the satellite signal signals of the satellite in the coverage area.

10. The device according to claim 5, and at least one multi-channel transceiver comprising a receiving unit and a generator and being connected on an input side thereof to the reference antenna and on an output side thereof to the transmitting antennas.

11. The device according to claim 5, wherein the generator for generating the coverage signals is set up so as to generate a replica signal for each of the transmitting antennas in the coverage area,
wherein the difference between the delay time between a predetermined target position in the transmission region of the respective transmitting antenna and the satellite and the delay time between the reference and the satellite is determined as a shift parameter Δt, and the replica signal is generated from the satellite position data and the signal pattern that has been temporally shifted by the shift parameter Δt,
wherein the satellite signal and the replica signal correspond in the peripheral area of the coverage area to such an extent that the satellite signal and the replica signal are not distinguished by the locator device, and
wherein the difference between the shift parameters Δt for replica signals of adjacent transmission regions is less than half the duration of the signal pattern.

12. The device according to claim 5, wherein the coverage area is divided into at least two coverage area units, at least two transmitting antennas being arranged in each coverage area unit.

13. The method according to claim 2, wherein a plurality of additional satellites each transmit a respective satellite signal, and the method further comprises
receiving the satellite signals of said plurality of additional satellites with the reference antenna;
extracting a respective repeating signal pattern and satellite position data from the satellite signal for each of the additional satellites;
determining a difference between the delay time between a predetermined target position in the transmission region of the respective transmitting antenna and the respective additional satellite and the delay time between the reference antenna and the respective additional satellite as a respective shift parameter Δt; and
generating the replica signal from the satellite position data and the signal pattern that has been temporally shifted by the respective shift parameter Δt; and
generating a coverage signal for the transmission region of a respective transmitting antenna from the replica signals transmitting antenna, and transmitting the coverage signal to the transmitting antenna.

14. The method according to claim 2, wherein the coverage area is subdivided into at least two coverage area units, at least two of said transmitting antennas being arranged in each coverage area unit.

15. The method according to claim 3, wherein the coverage area is subdivided into at least two coverage area units, at least two of said transmitting antennas being arranged in each coverage area unit.

16. The method according to claim 13, wherein the coverage area is subdivided into at least two coverage area units, at least two of said transmitting antennas being arranged in each coverage area unit.

17. The device according to claim 6, wherein the transmitting antennas are directional antennas.

18. The device according to claim 6, wherein the transmitting antennas are arranged in the coverage area such that the transmission regions thereof do not overlap.

19. The device according to claim 7, wherein the transmitting antennas are arranged in the coverage area such that the transmission regions thereof do not overlap.

20. The device according to claim 19, wherein the coverage signals transmitted by the transmitting antennas have a higher signal strength than the satellite signal of the satellite in the coverage area.
